(19) United States
(12) Patent Application Publication
(10) Pub. No.: US 2007/0163402 A1
(43) Pub. Date: Jul. 19, 2007

(54) Pivotable device for hand tools

(76) Inventor: Chih-Ching Hsieh, Taichung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/332,323

(22) Filed: Jan. 17, 2006

(51) Int. Cl. B25B 23/16

(52) U.S. Cl. 81/177.9; 81/177.8

(57) ABSTRACT

A pivotable head with a protrusion which is pivotably connected to an end of a handle and a threaded rod is movably inserted in the handle and removably contacts the protrusion so as to position the pivotable head at desired angles. The handle has an aperture in which a control member is rotatably received which is threadedly mounted to the threaded rod so that when rotating the control member, the threaded rod is moved axially to disengage from the protrusion or to contact the protrusion.

### FIELD OF THE INVENTION

The present invention relates to a device for pivoting and positioning a drive head of a hand tool.

### BACKGROUND OF THE INVENTION

A conventional hand tool with a pivotable drive head generally includes a handle and a drive head which is pivotably connected to the handle and a positioning device is used to position the drive head. A well known device includes a bead and a spring which pushes the bead toward the drive head which includes a plurality of notches at different angles so that when the bead is engaged with one of the notches, the drive head is positioned at that corresponding angle. The conventional positioning device has an inherent shortcoming which is that the spring is easily to be fatigue after a period of use and once the spring cannot provide sufficient force to firmly engage the bead with one of the notches, the drive head cannot be positioned at the desired position. Besides, the bead and the spring are so tiny such that it takes a lot of time to assemble the bead and the spring into holes drilled in the handle.

The present invention intends to provide a pivotable and positioning device for a drive head of a hand tool and the device includes a threaded rod which is movably in the handle and removably contacts the drive head so as to firmly position the drive head at desired angle.

### SUMMARY OF THE INVENTION

The present invention relates to a hand tool with a pivotable head, wherein the handle tool has two lugs extending from an end thereof and the head includes a protrusion which is pivotably connected between the two lugs. An aperture is defined through the handle and a passage is defined axially in the handle and in communication between the aperture and a space between the two lugs. A threaded rod is movably inserted into the passage and the aperture. A control member has a threaded inner periphery which is threadedly connected to the threaded rod so that the threaded rod is removably in contact with the protrusion of the head by rotating the control member.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the hand tool of the present invention;

FIG. 2 is a cross sectional view to show the hand tool of the present invention;

FIG. 2-1 is a side cross sectional view to show that the head is pivotable relative to the handle;

FIG. 3 shows that the threaded rod is removed away from the protrusion of the head;

FIG. 3-1 shows that the threaded rod is moved to contact the protrusion of the head;

FIG. 4 is perspective view of the hand tool of the present invention;

FIG. 5 is another embodiment of the hand tool of the present invention;

FIG. 6 is a cross sectional view to show the embodiment of the hand tool in FIG. 5;

FIG. 7 shows that the threaded rod is removed away from the protrusion of the head for the hand tool in FIG. 5, and FIG. 8 shows that the threaded rod is moved to contact the protrusion of the head for the hand tool in FIG. 5.

### DETAILED DESCRIPTION OF THE PREFERRED EMBODIMENT

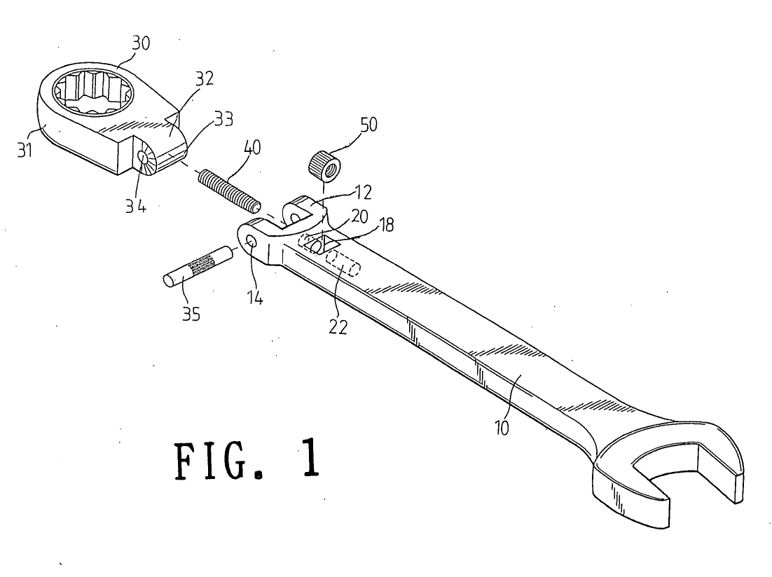

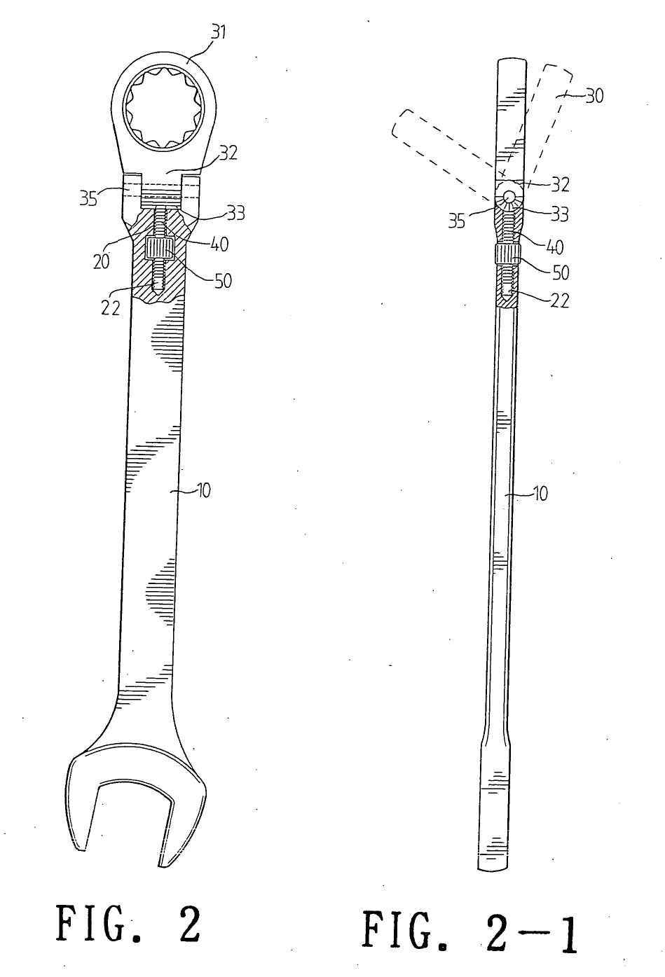

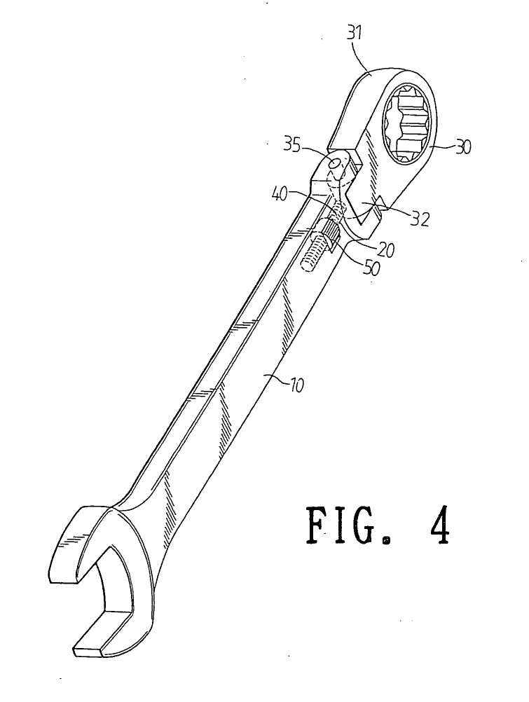

Referring to FIGS. 1, 2, 2-1, and 4, the hand tool of the present invention comprises a handle 10 and a head 31 is pivotably connected to the handle 10. The head 30 can be a ratchet box end 31 and a protrusion 32 extends from an end of the head 30. Two lugs 12 extend from an end of the handle 10 and an aperture 18 is defined through the handle 10. A passage 20 is defined axially in the handle 10 and in communication between the aperture 18 and a space between the two lugs 12. The protrusion 32 is pivotably located in the space by extending a pin 35 through two respective holes 14 in the two lugs 12 and the hole 34 in the protrusion 32. A recess 22 is defined axially in the handle 10 and in communication with the aperture 18 which is located between the passage 20 and the recess 22. The protrusion 32 includes a plurality of parallel ridges 33 on an outer periphery thereof.

A threaded rod 40 is movably inserted into the passage 20, the aperture 18 and the recess 22. A control member 50 is rotatably received in the aperture 18 and has a threaded inner periphery which is threadedly connected to the threaded rod 40 so that the threaded rod is removably in contact with the protrusion 32 of the head 30 by rotating the control member 50.

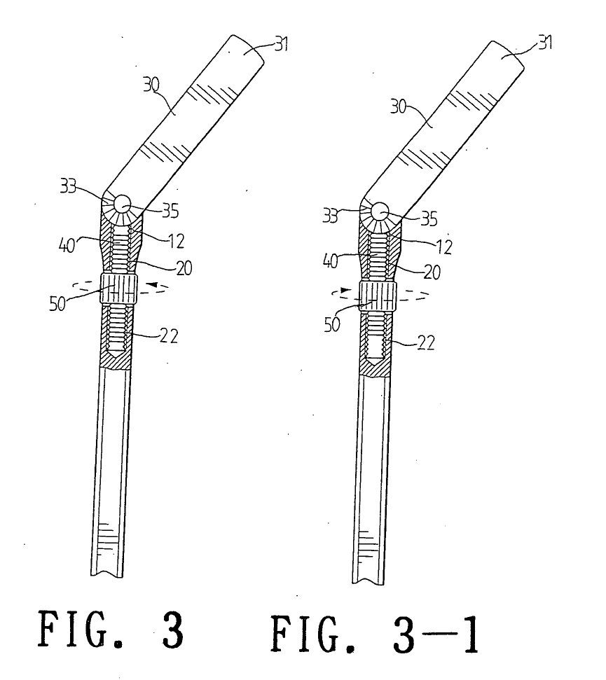

As shown in FIGS. 3 and 3-1, the threaded rod 40 is first lowered by rotating the control member 50 in one direction so as to be disengaged from the protrusion 32, the head 30 is then pivoted about the pin 35 to a desired angle. The control member 50 is then rotated in opposite direction to move the threaded rod 40 to contact the protrusion 32 to position the head 30. The ridges 33 on the protrusion 32 increase the friction between the protrusion 32 and the threaded rod 40.

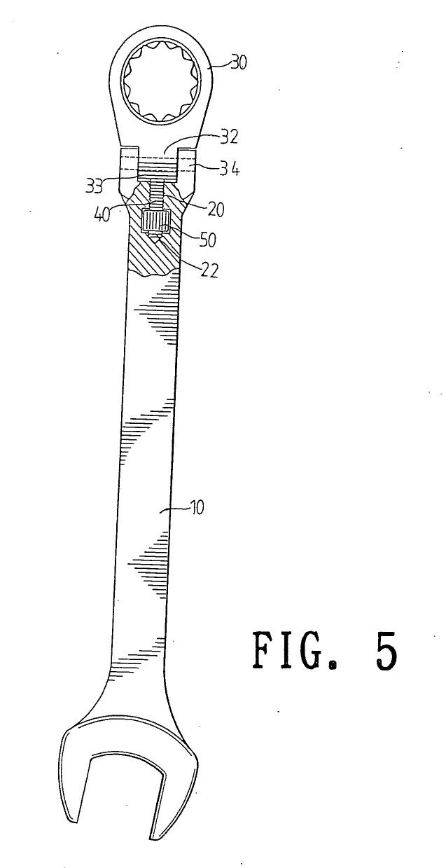

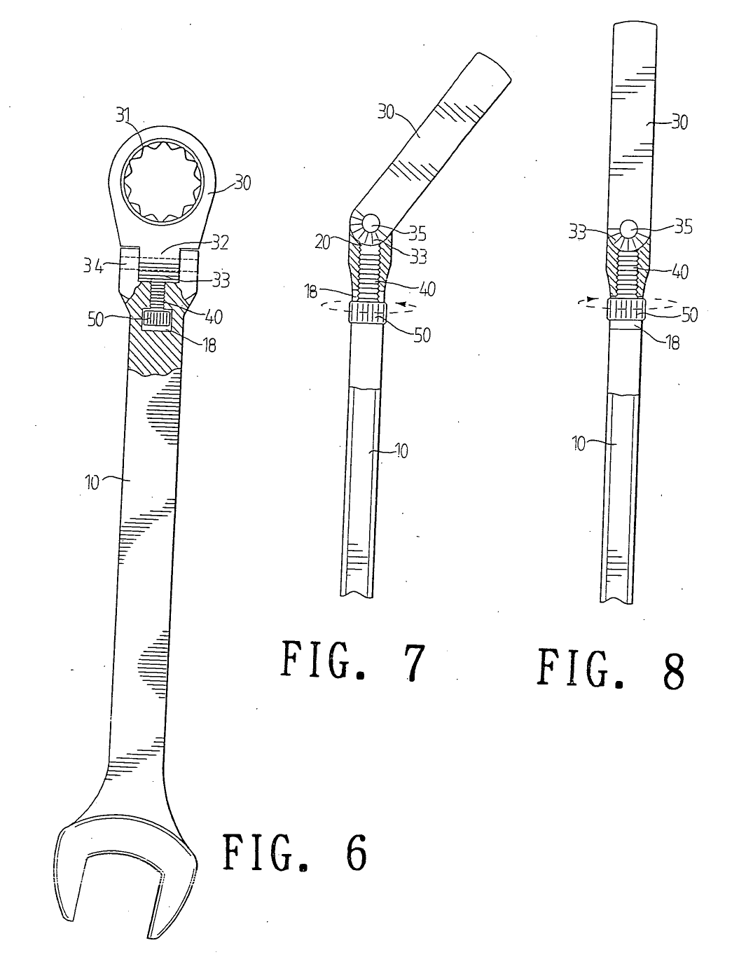

Referring to FIGS. 5 to 8, another embodiment of the present invention is disclosed wherein the recess 22 in the first embodiment can be omitted, wherein the length in the axial direction of the aperture is longer than the height of the control member 50 so that there is a space between the lower end of the control member 50 and an inside of the aperture 18. When rotating the threaded rod 40, the threaded rod 40 can be disengaged from the protrusion 32 and the lower end of the threaded rod 40 is received in the space between the lower end of the control member 50 and an inside of the aperture 18, so that the head 30 can be pivoted an angle as shown in FIG. 7. As shown in FIG. 8, when rotating the control member 50 in opposite direction, the threaded rod 40 is moved to contact the protrusion 32 of the head 30.

While we have shown and described the embodiment in accordance with the present invention, it should be clear to those skilled in the art that further embodiments may be made without departing from the scope of the present invention.

1. A hand tool comprising:
a handle, two lugs extending from an end of the handle and an aperture defined through the handle, a passage defined axially in the handle and in communication between the aperture and a space between the two lugs;
a head including a protrusion extending from an end thereof, the protrusion pivotably located in the space and a pin extending through the two lugs and the protrusion, the protrusion including a plurality of ridges extending from an outer periphery thereof, and
a threaded rod movably inserted into the passage and the aperture, a control member rotatably received in the aperture and having a threaded inner periphery which is threadedly connected to the threaded rod so that the threaded rod is removably in contact with the protrusion of the head by rotating the control member.

2. (canceled)

3. The hand tool as claimed in claim 1, wherein a recess is defined axially in the handle and in communication with the aperture which is located between the passage and the recess, a part of the threaded rod is received in the recess.
